(19) United States
(12) Patent Application Publication
(10) Pub. No.: US 2020/0409496 A1
(43) Pub. Date: Dec. 31, 2020

(54) TOUCH DISPLAY PANEL AND ELECTRONIC DEVICE

(71) Applicant: Wuhan China Star Optoelectronics Technology Co., Ltd., Wuhan, Hubei (CN)

(72) Inventor: Xifeng AN, Wuhan, Hubei (CN)

(21) Appl. No.: 16/472,886

(22) PCT Filed: Mar. 13, 2019
(86) PCT No.: PCT/CN2019/077912

§ 371 Date: Jun. 23, 2019

(30) Foreign Application Priority Data
Dec. 24, 2018 (CN) 201811581285.7

(51) Int. Cl. G06F 3/041

(52) U.S. Cl. CPC G06F 3/0412

(57) ABSTRACT

The present invention provides a touch display panel including a substrate, a buffer layer, a first metal layer, a gate insulating layer, a semiconductor layer, an interlayer insulating layer, a second metal layer, a planarization layer, a pixel electrode layer, an organic layer, and a common electrode layer; wherein the second metal layer includes touch lines and data lines forming sub-pixels in a vertical projection area of the semiconductor layer, wherein the sub-pixels are arranged on the substrate in an array, and the touch lines are disposed in the sub-pixels. The present invention provides the touch display panel, wherein a short circuit is not prone to occur when the touch lines and the data lines are formed into films at the same time, which is beneficial to reduce the occurrence of defects, thereby increasing product yield while reducing product costs.

### BACKGROUND OF INVENTION

### Field of Invention

The present invention relates to a field of display panel technologies, and in particular, to a touch display panel and an electronic device.

### Description of Prior Art

With development of touch technologies, electronic devices with touch control functions have entered people's daily lives, and organic light-emitting diode (OLED) display panels with the touch control functions have become a research hotspot in the display field. Touch screens can be classified into capacitive, electromagnetic, resistive, and optical types etc. Capacitive touch screens can be divided into an add-on touch panel, an on-cell touch panel, and an in-cell touch panel. The in-cell touch panel can embed touch electrodes in the OLED display panels to realize integration of touch control and display, thereby reducing the manufacturing cost of the touch screens, reducing the thickness of the touch screens, and reducing the volume and weight of the touch screens.

An ultra-thin integrated touch screen in-cell touch panel (ITP) integrates the touch control function into a liquid crystal display, and a touch-sensing pattern is formed between two pixels to block generation of a regular interference pattern caused by superimposing the pixels. With gradual popularization of low temperature poly-silicon (LTPS) panels, array circuit designs have become more and more refined, and pixels per inch (PPI) of small-sized panels has gradually increased.

In the prior art, a second metal layer is used as a touch trace to realize the ultra-thin integrated touch screen. As shown in FIG. 1a, a touch display panel includes a substrate 10, a buffer layer 20, a first metal layer 21, a semiconductor layer 30, a gate insulating layer 40, an interlayer insulating layer 50, a second metal layer, a planarization layer 70, a pixel electrode layer 80, an organic layer 90, and a common electrode layer 100, which are sequentially disposed. The second metal layer includes data lines 61 and touch lines 62. As shown in FIG. 1b, the touch lines 62 are disposed near the data lines 61. A distance between the touch lines 62 and the data lines 61 is L1, and a length of L1 is less than 0.25 um. In this manner, the touch lines and the second metal layer are formed into films simultaneously, and short-circuiting between the touch lines and the data lines often occurs due to their proximity.

Therefore, it is indeed necessary to develop a novel touch display panel to overcome the drawbacks of the prior art.

An object of the present invention is to provide a touch display panel capable of solving the problem that a short circuit is easily generated when touch lines and data lines are simultaneously formed in a touch display panel in the prior art.

### SUMMARY OF INVENTION

To achieve the above object, the present invention provides a touch display panel including a substrate, a buffer layer, a first metal layer, a gate insulating layer, a semiconductor layer, an interlayer insulating layer, a gate metal layer, a second metal layer, a planarization layer, a pixel electrode layer, an organic layer, and a common electrode layer disposed sequentially, wherein the second metal layer comprises a plurality of touch lines and a plurality of data lines forming a plurality of sub-pixels in a vertical projection area of the semiconductor layer, the sub-pixels are arranged in an array on the substrate, and the touch lines are disposed in the sub-pixels.

Further, in other embodiments, each of the sub-pixel has a width ranging from 13 um to 26 um.

Further, in other embodiments, a first distance between each of the touch lines and one of the data lines adjacent to a left side thereof ranges from 0.25 um to 26 urn. The first distance is preferably 13 um. In other embodiments, the first distance may be determined according to requirements, and is not particularly limited as long as no short circuit occurs when the touch lines and the data lines adjacent to left sides thereof are formed into films.

Further, in other embodiments, a second distance between each of the touch lines and one of the data lines adjacent to a right side thereof ranges from 0.25 um to 26 um. The second distance is preferably 13 um. In other embodiments, the second distance may be determined according to requirements, and is not particularly limited as long as no short circuit occurs when the touch lines and the data lines adjacent to right sides thereof are formed into films.

Further, in other embodiments, the common electrode layer is connected to the data lines, and the pixel electrode layer is connected to the touch lines.

Further, in other embodiments, the data lines are distributed among the array of the sub-pixels, and each of the sub-pixels is connected to a corresponding one of the data lines, and the data lines are configured to provide a plurality of data signals to the sub-pixels.

Further, in other embodiments, the touch display panel further includes a plurality of scan lines distributed among the array of the sub-pixels, wherein each of the sub-pixels is connected to a corresponding one of the scan lines, and the scan lines are configured to provide a plurality of scan signals to the sub-pixels.

Further, in other embodiments, the touch lines are insulated from the data lines.

Further, in other embodiments, the scan lines are made of a metal material comprising molybdenum.

Another object of the present invention is to provide an electronic device including a body on which the touch display panel according to the present invention is disposed.

Compared with the prior art, the present invention provides a touch display panel, wherein an area occupied by sub-pixels disposed on a substrate thereof is widen, so that there is a sufficient space for placing the touch lines therein. The data lines are outside the sub-pixels, so that a distance between the touch lines and the data lines is increased, and thus a short circuit is not prone to occur when they are formed into films at the same time, which is beneficial to reduce the occurrence of defects, thereby increasing product yield while reducing product costs. After the improvement, a rate of the short circuit occurred when the touch lines and the data lines were simultaneously formed into the films is reduced from 5.3% to 0.38%, and the improvement effect is 92.8% increase compared with the pre-improvement rate.

### BRIEF DESCRIPTION OF DRAWINGS

In order to more clearly illustrate the embodiments or the technical solutions of the existing art, the drawings illustrating the embodiments or the existing art will be briefly described below. Obviously, the drawings in the following description merely illustrate some embodiments of the present invention. Other drawings may also be obtained by those skilled in the art according to these figures without paying creative work.

FIG. 1a is a cross-sectional view of a touch display panel of a prior art.

FIG. 1b is a schematic diagram of a planar structure of a touch display panel of a prior art.

FIG. 2 is a cross-sectional view of a touch display panel according to Embodiment 1 of the present invention.

FIG. 3 is a schematic diagram of a planar structure of a touch display panel according to Embodiment 1 of the present invention.

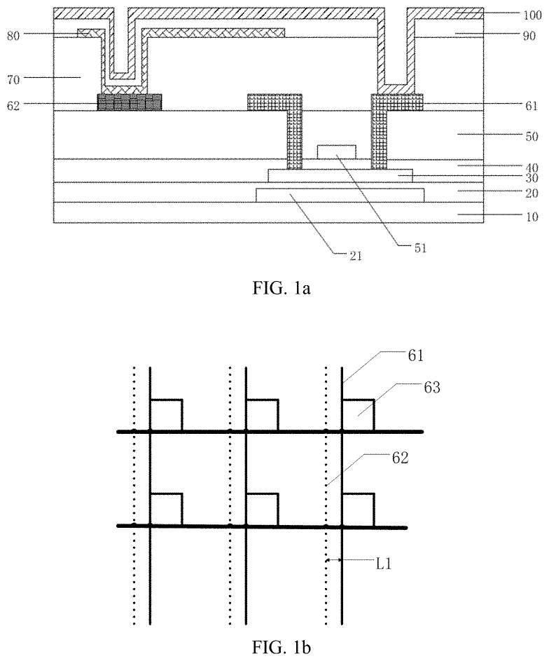

### DETAILED DESCRIPTION OF PREFERRED EMBODIMENTS

Please refer to the figures in the drawings, in which, like numbers refer to like elements throughout the description of the figures. Hereinafter, the present invention will be described in further detail with reference to examples. It is to be understood, however, that these examples are for illustrative purposes only and are not intended to limit the scope of the present invention.

The following disclosure provides many different embodiments, or examples, for implementing different features of the invention. Specific examples of components and arrangements are described below to simplify the present disclosure. These are, of course, merely examples and are not intended to limit the invention.

In the description of the present invention, it is to be understood that the terms “center”, “lateral”, “upper”, “lower”, “left”, “right”, “vertical”, “horizontal”, “top”, “bottom”, “inside”, “outside” and the like are based on the orientation or positional relationship shown in the drawings, and is merely for the convenience of describing the present invention and simplifying the description, and does not indicate or imply that the indicated devices or components must to be in particular orientations, or constructed and operated in a particular orientation, and thus are not to be construed as limiting the invention. Furthermore, the terms “first”, “second”, etc. in the specification and claims of the present invention and the above figures are used to distinguish similar objects, and are not necessarily used to describe a specific order or prioritization. It should be understood that the objects so described are interchangeable when it is appropriate. Moreover, the terms “including” and “having” and any variations thereof are intended to cover a non-exclusive “inclusion”.

In the description of the present invention, it should be noted that the terms “installation”, “connection”, and “bonding” are to be understood broadly unless otherwise explicitly defined and limited. For example, it may be fixed connection, detachable connection, or integrally connection; being mechanical or electrical connection; also, being directly connection, indirectly connection through an intermediate medium, or internal communication of two components. The specific meaning of the above terms in the present invention can be understood in a specific case by those skilled in the art.

The terminology used herein is for the purpose of describing particular embodiments only and is not intended to be limiting of exemplary embodiments. The singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, components and/or groups thereof, but do not preclude the presence or addition of one or more other features, integers, steps, operations, elements, components and/or groups thereof.

### Embodiment 1

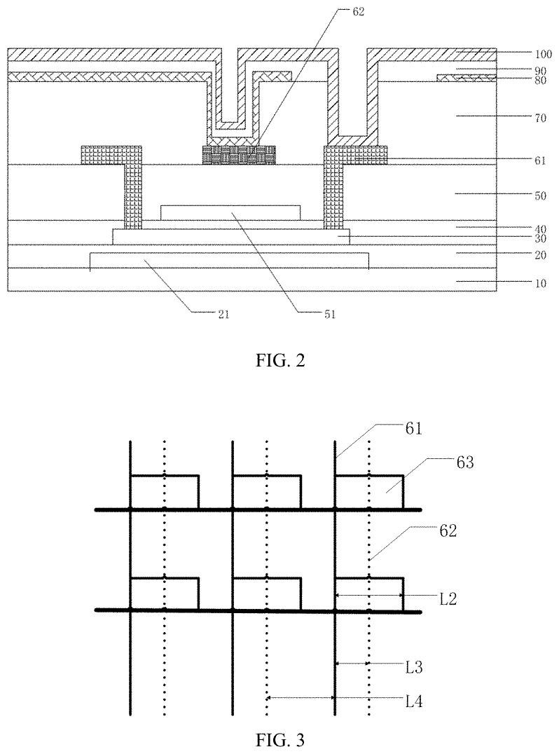

FIG. 2 is a cross-sectional view of a touch display panel according to Embodiment 1 of the present invention. As shown in FIG. 2, the touch display panel provided in Embodiment 1 includes a substrate 10, a buffer layer 20, a metal light shielding layer 21, a semiconductor layer 30, a gate insulating layer 40, an interlayer insulating layer 50, a gate electrode metal layer 51, a planarization layer 70, a pixel electrode layer 80, an organic layer 90, and a common electrode layer 100 disposed sequentially.

The substrate 10 is glass and serves as a base of the display panel.

The buffer layer 20 is disposed on a surface of the substrate 10, and the semiconductor layer 30 is disposed on the buffer layer 20. Material of the semiconductor layer 30 is polycrystalline silicon converted from amorphous silicon by excimer laser annealing. The gate insulating layer 40 is disposed on a surface of the buffer layer 20. The interlayer insulating layer 50 is disposed on a surface of the gate insulating layer 40. The planarization layer 70 is disposed on a surface of the interlayer insulating layer 50. The pixel electrode layer 80 is disposed on a surface of the planarization layer 70. The common electrode layer 100 is disposed on a surface of the organic layer 90. In the present embodiment, Material of the gate insulating layer 40 may be silicon nitride, silicon oxide, silicon oxynitride or the like, and it may be specifically determined according to requirements, and is not limited.

A gate metal layer 51, that is, scan lines, is disposed on the gate insulating layer 40 for controlling on and off switches of thin film transistors (TFTs).

A second metal layer is disposed on the interlayer insulating layer 50. The second metal layer includes data lines 61 and touch lines 62 insulated from each other. The common electrode layer 100 is connected to the data lines 61, and the pixel electrode layer 80 is connected to the touch lines 62.

FIG. 3 is a schematic diagram of a planar structure of a touch display panel according to an embodiment of the present disclosure. As shown in FIG. 3, the touch display panel of the present disclosure includes a plurality of data lines 61, a plurality of touch lines 62, and a plurality of sub-pixels 63 arranged in an array, and the touch lines 62 and the data lines 61 are distributed among the array of the sub-pixels.

Each of the sub-pixels 63 is connected to a corresponding one of the data lines 61 configured to provide data signals to the sub-pixels 63. The touch display panel further includes a plurality of scan lines, wherein each of the sub-pixels 63 is connected to corresponding one of the scan lines configured to provide scan signals to the sub-pixels 63.

Each of the touch lines 62 is disposed between two adjacent data lines 61. Each of the touch lines 62 is disposed in the middle of the sub-pixels 63. A width L2 of the sub-pixel is 25 um. A distance between the touch line and data line adjacent to the left side thereof has a first distance L3 of 13 um; and a distance between the touch line and the data line adjacent to the right side thereof has a second distance L4.

In other embodiments, the first distance ranges from 0.25 um to 26 um, which can be determined according to requirements, and is not particularly limited as long as no short circuit occurs when the touch lines and the data lines adjacent to left sides thereof are formed into films.

### Embodiment 2

A further embodiment of the present invention provides an electronic device including a body on which the touch display panel provided in Embodiment 1 is disposed.

An advantageous effect of the present invention is that the present invention provides a touch display panel, wherein an area occupied by sub-pixels disposed on a substrate thereof is widened, so that there is sufficient space for placing the touch lines therein. The data lines are outside the sub-pixels, so that a distance between the touch lines and the data lines is increased, and thus a short circuit is not prone to occur when they are formed into films at the same time, which is beneficial to reduce the occurrence of defects, thereby increasing product yield while reducing product costs. After the improvement, a rate of the short circuit occurred when the touch lines and the data lines simultaneously formed into the films is reduced from 5.3% to 0.38%, and the improvement effect increases 92.8% compared with the rate before improvement.

While the invention has been described in detail and with reference to specific embodiments thereof, it is to be understood that the foregoing description is exemplary and explanatory in nature and is intended to illustrate the invention and its preferred embodiments. Through routine experimentation, one skilled in the art will readily recognize that various changes and modifications can be made therein without departing from the spirit and scope of the invention.

1. A touch display panel, comprising: a substrate, a buffer layer, a first metal layer, a gate insulating layer, a semiconductor layer, an interlayer insulating layer, a gate metal layer, a second metal layer, a planarization layer, a pixel electrode layer, an organic layer, and a common electrode layer disposed sequentially, wherein the second metal layer comprises a plurality of touch lines and a plurality of data lines forming a plurality of sub-pixels in a vertical projection area of the semiconductor layer, the sub-pixels are arranged in an array on the substrate, and the touch lines are disposed in the sub-pixels.

2. The touch display panel according to claim 1, wherein each of the sub-pixel has a width ranging from 13 um to 26 um.

3. The touch display panel according to claim 1, wherein a first distance between each of the touch lines and one of the data lines adjacent to a left side thereof ranges from 0.25 um to 26 um.

4. The touch display panel according to claim 1, wherein a second distance between each of the touch lines and one of the data lines adjacent to a right side thereof ranges from 0.25 um to 26 um.

5. The touch display panel according to claim 1, wherein the common electrode layer is connected to the data lines, and the pixel electrode layer is connected to the touch lines.

6. The touch display panel according to claim 1, wherein the data lines are distributed among the array of the sub-pixels, and each of the sub-pixels is connected to a corresponding one of the data lines, and the data lines are configured to provide a plurality of data signals to the sub-pixels.

7. The touch display panel according to claim 1, further comprising a plurality of scan lines distributed among the array of the sub-pixels, wherein each of the sub-pixels is connected to a corresponding one of the scan lines, and the scan lines are configured to provide a plurality of scan signals to the sub-pixels.

8. The touch display panel according to claim 1, wherein the touch lines are insulated from the data lines.

9. The touch display panel according to claim 7, wherein the scan lines are made of a metal material comprising molybdenum.

10. An electronic device, comprising: a body on which the touch display panel according to claim 1 is provided.

11. The electronic device according to claim 10, wherein each of the sub-pixels has a width ranging from 13 um to 26 um.

12. The electronic device according to claim 10, wherein a first distance between each of the touch lines and one of the data lines adjacent to a left side thereof ranges from 0.25 um to 26 um.

13. The electronic device according to claim 10, wherein a second distance between each of the touch lines and one of the data lines adjacent to a right side thereof ranges from 0.25 um to 26 um.

14. The electronic device according to claim 10, wherein the common electrode layer is connected to the data lines, and the pixel electrode layer is connected to the touch lines.

15. The electronic device according to claim 10, wherein the data lines are distributed among the array of the sub-pixels, and each of the sub-pixels is connected to a corresponding one of the data lines, and the data lines are configured to provide a plurality of data signals to the sub-pixels.

16. The electronic device according to claim 10, further comprising a plurality of scan lines distributed among the array of the sub-pixels, wherein each of the sub-pixels is connected to a corresponding one of the scan lines, and the scan lines are configured to provide a plurality of scan signals to the sub-pixels.

17. The electronic device according to claim 10, wherein the touch lines are insulated from the data lines.

18. The electronic device according to claim 16, wherein the scan lines are made of a metal material comprising molybdenum.
